(19) United States
(12) Patent Application Publication
(10) Pub. No.: US 2005/0216373 A1
(43) Pub. Date: Sep. 29, 2005

(54) System and method for electronically transmitting information at completion of live sales transaction

(76) Inventors: Jeffrey Weiss, Potomac, MD (US); Gerson Panitch, Potomac, MD (US)

Correspondence Address: WEISS & MOY PC, 4204 NORTH BROWN AVENUE, SCOTTSDALE, AZ, 85251, US

(21) Appl. No.: 11/068,398

(22) Filed: Feb. 28, 2005

Related U.S. Application Data
(60) Provisional application No. 60/547,980, filed on Feb. 26, 2004.

(51) Int. Cl. G06F 17/60

(52) U.S. Cl. 705/28

(57) ABSTRACT

Information concerning the subject of a live sales transaction between a purchaser and a seller is communicated electronically from the seller to the purchaser. By way of example, transmission may be to a device in the physical possession of the purchaser to an e-mail address or other location designated by the purchaser. The types of information that may be communicated includes receipt information, warranty information, assembly instructions, and/or other desired information relating to the subject of the live sales transaction.

### RELATED APPLICATION

This non-provisional application claims priority from provisional application No. 60/547,980 filed on Feb. 26, 2004.

### FIELD OF THE INVENTION

This invention relates generally to the provision of information on the completion of a sales transaction and, more particularly, to the provision of information (including for example a receipt) in an electronic form to a purchaser, following a sales transaction concluded in a live setting between a purchaser and a seller.

### BACKGROUND OF THE INVENTION

In all manner of live sale transactions, information is provided to the seller in connection with the purchase. These include receipts, warranty information, instructions, coupons, sales offers, and other information.

For example, an individual purchasing office supplies in an office supply store will receive an itemized receipt for the purchase, listing the items purchased and the amounts paid. The same would be true for grocery purchases, hardware purchases, etc. There are purchases of services, as well as of goods, where this also occurs. Examples would include the checking out of a hotel, the return of a rental car, and the like.

Currently, receipts following the completion of a live sale transaction are provided in paper form. Typically, a receipt is printed by a cash register or similar device, and handed to the purchaser.

Receipts can have significance for purchasers for a number of reasons. They may be needed for purposes of seeking reimbursement for a business purchase. They may need to be saved for tax purposes. They may serve as proof of purchase for warranty reasons. They also contain purchase information that may be of use to a purchaser, in terms of tracking expenses.

Current paper receipts are vulnerable to loss. In addition, they are not in electronic form, where they could be e-mailed, maintained electronically in a computer file, or mined for data contained therein.

Purchasers also often receive at the time of purchase other information. This may include coupons (for example on the reverse side of a grocery store receipt), warranty information, and instructions. With respect to warranty information and instructions, these are typically in paper form within the packaging for the item sold. Like receipts, such information is easily misplaced, so that it may not be available when needed at a later time.

A need therefore exists for a system and method for providing information of a type typically provided at the completion of a sales transaction, in an electronic form.

### DETAILED DESCRIPTION OF EMBODIMENTS

Initially, it should be noted that the term “live sale transaction” is intended to encompass sale/purchase transactions of goods or services completed in a setting where the purchaser and a seller (or seller's representative) are both physically present. Examples include the check-out counter at a supermarket, electronics or other “brick and mortar” retail store, hotel, car rental agency, restaurant, taxi, and the like. It is meant to exclude transactions, such as Internet purchases, telephone purchases, and the like, where the purchaser and seller (or seller's representative) are in physically different locations at the time that the transaction is completed.

The basic steps in the practice of one embodiment of the present invention are as follows. During a financial transaction, or after a financial transaction is completed, such as in a live setting between a seller and a purchaser, information relating to the financial transaction, or otherwise desired to be communicated by the seller to the customer, is then communicated from the seller to the customer in electronic form

It should be noted that the electronic communication of the information can take several forms. For example, communication could utilize infrared technology, with a seller transmitting unit “beaming” the receipt to an IR port in a unit held by the purchaser. Suitable purchaser units could include a PDA, wireless telephone, mobile computing device, or other device having the capacity to receive an IR transmission. The transmission could also be sent to any such device in a wireless, non-infrared format. For example, Bluetooth, WiFi, 802.11, or any other existing or future communications protocol might be employed.

The seller unit can be a dedicated unit adapted for this purpose, and in communication with the cash register or other device into which information regarding the sale transaction is inputted by the seller. The seller unit may also be a modified version of the current payment terminals that are widely utilized in retail shopping environments. In addition, the seller unit may itself be a hand-held device, in particular in environments (for example in a taxi or a restaurant table) where seller and purchaser are not completing a transaction across a countertop.

In automated transactions, such as during the purchase of gasoline, the purchase of goods from vending machines, the use of an automated teller machine, or during other forms of automated transactions, the electronic transactional information might be transmitted automatically, or alternatively following an affirmative response by a purchaser to some form of prompt.

Whether automated or not, a signal from the user's communication device might trigger the transmission of the electronic receipt or other transaction related information.

In one preferred embodiment, the information transmitted is a receipt. Preferably, the receipt is itemized, and reflects one or more of the total amount of the purchase, the amounts of the individual purchases comprising the total, and the identity of items or services purchased. Indeed, the extent of the information contained in the receipt may mirror the quantum of information typically provided in a paper receipt for the same transaction.

Given that the information is provided in an electronic format, it may be preferable to have the receipt contain more complete information than is contained on a typical, equivalent, paper receipt. For example, product descriptions that are abbreviated in a paper supermarket receipt, in the interest of keeping such receipts relatively small, need not be abbreviated in an electronic format - or perhaps could be provided in both abbreviated and non-abbreviated forms.

The purchaser may transmit the receipt as a file or otherwise, by e-mail or in some other manner (for example some form of wireless transmission between two wireless devices). For example, such transmission may be desired for the submission of a receipt for reimbursement purposes. In addition or alternatively, the purchaser may desire to “file” the receipt electronically, for record-keeping purposes or the like.

In another embodiment, the transmitted information may be coupons or other promotional information. Such information may be transmitted to the user as function of the transaction that just took place. For example, if the user purchased a brand of laundry detergent, an electronic coupon for a competing brand might be transmitted. Alternatively, the transmitted information might be a function of historical information. For example, if a customer has purchased the same brand of detergent for the last year, the system might send a more deeply discounted coupon in an attempt to convert a loyal customer. The forgoing types of communications might be enhanced through the use of a central server that enables global tracking of a consumer's purchasing habits, rather than, for example, the habits with respect to a particular vendor.

In one embodiment, software may be utilized to mine electronic information received from vendor. For example, a purchaser wishing to determine an amount of money spent on a particular category of items (e.g., breakfast cereal, paper, pens, soda) may determine this by extracting such information utilizing software that may obtain such information from a search of stored receipts. The software might enable such custom searches to be performed. Alternatively, or in addition, the software might automatically sort receipts, or subcomponents of the receipts into predefined categories. For example, the software might recognize that a receipt item bearing a “bread” designation might automatically be placed in a food expense category, while a gasoline receipt automatically is categorized under an automobile expense category. The user might be afforded the opportunity to define categories and set parameters. Such software might be maintained on a website accessible to the user or directly within the user's personal or mobile computer or mobile computing device.

Collected information can be useful in terms of organizing a budget, maintaining control of expenses, comparison shopping, and so on. Similarly, a corporation, agency or other organization receiving large volumes of electronic receipts from multiple purchasers may wish to “mine” the data received for purposes of tracking reimbursable expenses in a more detailed fashion.

In one embodiment, as an alternative to communication of the information to a unit held by the purchaser, the purchaser could provide an e-mail address or other electronic identifier to the seller, so that the electronic information may be communicated thereto. Such address could be provided at the time of completion of the sales transaction, for example orally by telling it to the seller, by typing it into a keypad located at the site (for example as part of the payment terminal), or in some other convenient form. Alternatively, the purchaser could associate the e-mail address with a membership type card provided by the seller or with a credit card used to make the purchase. In this embodiment, the use of the card can trigger the sending of electronic information to the designated e-mail address, relating to the sale transaction. Alternatively, the information may be posted to a web-site, from where it can be accessed and downloaded by a purchaser, perhaps utilizing a unique identification code or the like.

This embodiment, i.e., in which information is later transmitted to the purchaser via e-mail or by posting to a web-site, rather than immediately communicated to a hand-held unit in the possession of the purchaser, is not intended to encompass the subsequent, non-purchase related transmission of newsletters or advertisements to an e-mail address provided by the purchaser. Instead, the intent is to specifically encompass the transmission of a receipt, warranty information, instructions, or other purchase-specific information in an electronic form.

1. A method for recording information regarding a live sales transaction comprising:
in connection with a live sales transaction between a purchaser and a seller physically present at an establishment, facilitating electronic transmission of information relating to the live sales transaction to the purchaser.

2. The method of claim 1 wherein the establishment is a retail sales location.

3. The method of claim 1 wherein said facilitating step comprises facilitating wireless transmission of the information to a device in physical possession of the purchaser at a location of said live sales transaction.

4. The method of claim 3 wherein the device is a PDA.

5. The method of claim 1 wherein said facilitating step comprises facilitating electronic transmission of the information to one of an e-mail addresses designated by the purchaser and a web-site.

6. The method of claim 1 wherein a subject of the live sales transaction is a service.

7. The method of claim 1 wherein a subject of the live sales transaction is a good.

8. The method of claim 1 wherein the information is an itemized receipt relating to a subject of the live sales transaction identifying particular subjects of the live sales transaction.

9. The method of claim 1 wherein the information is warranty information relating to a subject of the live sales transaction.

10. The method of claim 1 wherein the information is assembly instructions relating to a subject of the live sales transaction.

11. The method of claim 1 further comprising facilitating transmission of the information from a purchaser to a third party.

12. The method of claim 1 further comprising facilitating electronic mining of data from the information by one of the purchaser and a third party.

13. The method of claim 5 further comprising facilitating receiving from the purchaser the e-mail address.

14. The method of claim 13 wherein the e-mail address is received at a location of the live sales transaction.

15. The method of claim 5 wherein the e-mail address is associated with one of a credit and debit card utilized by the purchaser.

16. The method of claim 5 wherein the e-mail address is associated with a membership card associated with the seller.

17. A method for recording information regarding a live sales transaction comprising:
in connection with a live sales transaction between a purchaser and a seller physically present at an establishment, facilitating electronic transmission of information relating to the live sales transaction to the purchaser;
wherein the establishment is a retail sales location; and
wherein said facilitating step comprises facilitating wireless transmission of the information to a device in physical possession of the purchaser at a location of said live sales transaction.

18. The method of claim 17 wherein the information is an itemized receipt relating to a subject of the live sales transaction identifying particular subjects of the live sales transaction.

19. The method of claim 17 wherein the information is warranty information relating to a subject of the live sales transaction.

20. A method for recording information regarding a live sales transaction comprising:
in connection with a live sales transaction between a purchaser and a seller physically present at an establishment, facilitating electronic transmission of information relating to the live sales transaction to the purchaser;
wherein the establishment is a retail sales location;
wherein said facilitating step comprises facilitating electronic transmission of the information to an e-mail addresses designated by the purchaser; and
wherein the information is an itemized receipt relating to a subject of the live sales transaction identifying particular subjects of the live sales transaction.
